(19) United States
(12) Patent Application Publication
(10) Pub. No.: US 2022/0036265 A1
(43) Pub. Date: Feb. 3, 2022

(54) ENHANCING REMOTE WORK PRODUCTIVITY DATA

(71) Applicant: MICROSOFT TECHNOLOGY LICENSING, LLC, Redmond, WA (US)

(72) Inventors: Longqi YANG, Bellevue, WA (US); Sonia Patricia JAFFE, Seattle, WA (US); David Michael HOLTZ, Brooklyn, NY (US); Siddharth SURI, Redmond, WA (US); Shilpi SINHA, Bellevue, WA (US); Jeffrey Michael WESTON, Seattle, WA (US); Connor Michael JOYCE, Seattle, WA (US); Neha Parikh SHAH, New York, NY (US); Kevin Scott SHERMAN, Redmond, WA (US); Chia-Jung LEE, Kirkland, WA (US); Brent Jaron HECHT, Redmond, WA (US); Jaime TEEVAN, Bellevue, WA (US)

(21) Appl. No.: 16/942,375

(22) Filed: Jul. 29, 2020

(51) Int. Cl. G06Q 10/06; G06Q 10/10; G06F 16/26; G06N 20/00; G06N 5/04; G06F 3/0484; G06F 3/0482

(52) U.S. Cl. CPC G06Q 10/0639; G06Q 10/105; G06F 16/26; G06Q 10/06375; G06N 5/04; G06F 3/04847; G06F 3/0482; G06N 20/00

(57) ABSTRACT

Methods, computer systems, computer-storage media, and graphical user interfaces are provided for enhancing remote work productivity data. In one embodiment, worker data is obtained for a set of target workers and a set of control workers. The target workers are generally identified as working in the office prior to a treatment date and working remote after a treatment date, and the control workers are generally identified as working remote before and after the treatment date. Thereafter, an effect of working remotely is determined using a difference-in-differences model that measures differences in observational changes between the set of target workers and the set of control workers measured before and after the treatment date. The effect of working remotely can be used to generate a generating a productivity score indicating an extent of productivity in relation to the set of target workers.

### BACKGROUND

Remote work practices have been employed by various organizations over the years. Recently, such remote work practices have become even more prevalent, and even required in many cases due to local or global circumstances, such as the COVID-19 pandemic. As such, it has become increasingly desirable to understand the impact of working from home. For example, understanding the impact of working from home can facilitate analysis of workplace productivity. As another example, understanding the impact of working from home can help inform decisions related to policies, procedures, and/or technology implemented by an organization. Ensuring accurate data related to remote work, however, can be costly and time consuming. For example, identifying the data to analyze and accurately analyzing the data in light of unobservable differences among workers and remote work transitions can be tedious and time intensive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, enhancing remote work productivity data. In particular, embodiments described herein enhance remote work productivity data, such as remote work effect, by controlling for unobserved confounding factors (e.g., using a difference-in-differences framework). At a high level, using a difference-in-differences approach enables measurement of the difference between a treatment group and a control group in the change in the outcome variable that occurs over time. In this way, using a difference-in-differences approach separates the causal impact of remote work from differences between groups and over time thereby resulting in a more accurate identification of remote work effects.

In addition to improving accuracy of analysis of workplace productivity as it relates to remote work, embodiments described herein enable customized data analysis related to remote work in an automated and dynamic manner. As such, instead of manually gathering and analyzing data related to remote work, embodiments described herein enable a user (e.g., a business decision maker, team manager, or the like) to efficiently view remote work impact as desired by the user. In this regard, a user may specify (e.g., via a graphical user interface) productivity parameters for use in generating productivity data related to remote work. Based on various parameters selected or input by a user, a set of corresponding worker data can be obtained and used, via a difference-in-differences model, to determine a treatment effect (e.g., effect of remote work) in relation to the desired user-specified productivity parameters. Tailoring desired productivity data in relation to remote work effects enables users to view data relevant to the user in an efficient and accurate manner.

### BRIEF DESCRIPTION OF THE DRAWINGS

The technology described herein is described in detail below with reference to the attached drawing figures, wherein:

FIG. 1 is a block diagram of an exemplary system for enhancing remote work productivity data, suitable for use in implementing aspects of the technology described herein;

FIG. 2 is an example implementation for enhancing remote work productivity data, via a productivity engine, in accordance with aspects of the technology described herein;

FIG. 3 provides a first example method for enhancing remote work productivity data, in accordance with aspects of the technology described herein;

FIG. 4 provides a second example method for enhancing remote work productivity data, in accordance with aspects of the technology described herein;

FIG. 5 provides a third example method for enhancing remote work productivity data, in accordance with aspects of the technology described herein; and

FIG. 6 is a block diagram of an exemplary computing environment suitable for use in implementing aspects of the technology described herein.

### DETAILED DESCRIPTION

The technology described herein is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Workplace productivity analytics can enable an organization to evaluate the work practice of an organization, or aspects thereof (e.g., individual or group productivity). In understanding workplace productivity, one important aspect is understanding how remote working, or working from home (WFH), impacts workplace productivity. In particular, as organizations consider various remote work options for employees (e.g., based on individuals seeking remote work options or organizations choosing or being required to implement remote work options), it may be valuable for decision makers to understand how remote work impacts productivity from an organizational, group, and/or an individual perspective.

To analyze remote work, some studies have analyzed cross-sectional data, that is, data associated with a specific point in time. However, without some form of experiment, analyzing data associated with a particular point in time does not enable accurate causal conclusions pertaining to the impact or effect of remote work. In particular, a comparison of employees working from home against employees working in an office is likely to result in a biased estimate of the causal effect of remote work, in part, due to remote employees differing from office employees in important and generally unobservable ways (e.g., type of work, working styles, or the like). Further, a comparison of outcomes associated with individuals previously working in an office as compared to the same individuals later working from home (e.g., due to COVID-19) is unlikely to generate credible causal estimates associated with remote work. For example, observed differences may be a result of any number of factors unrelated to transitioning from office work to remote work, such as, for example, seasonal, business, and/or personal changes. By way of example only, assume a comparison of pre-COVID-19 and post-COVID-19 outcomes for employees who were previously working in an office is performed. In such a case, any observed differences may be a result of various factors unrelated to remote work, such as seasonal changes in work behavior and COVID-19 related impacts (e.g., childcare responsibilities, social isolation, and anxiety). Moreover, with these conventional approaches, manually identifying and analyzing data associated with workers can be tedious and time consuming, thereby resulting in more static studies being performed.

As such, embodiments described herein enhance remote work productivity data by controlling for unobserved confounding factors (e.g., using a difference-in-differences framework). At a high level, using a difference-in-differences approach enables measurement of the difference between a treatment group and a control group in the change in the outcome variable that occurs over time. In this way, using a difference-in-differences approach separates the causal impact of remote work from other differences between groups and over time, thereby resulting in a more accurate identification of remote work effects.

Advantageously, using a difference-in-differences approach to assess remote work productivity enables a more accurate causal estimate of the effect of remote working on workplace productivity as both time invariant differences between the two groups of workers and temporal trends common to the two groups of workers are taken into account. By way of example only, outcomes occurring over time (e.g., before and after COVID-19 resulted in remote work mandates) of a control group including individuals that worked remotely prior to COVID-19 can be compared to outcomes occurring over time (e.g., before and after COVID-10 resulted in remote work mandate) of a treatment group including individuals that worked in the office prior to COVID-19. The change in outcomes for the control group during the remote work mandate captures the effects of seasonality, product cycles, isolation, and/or other effects resulting from business and COVID-19. As such, the difference between the control group's change in outcome and the outcome change for the treatment group, including those who had previously worked in an office, is attributed to the treatment group's transition to remote work. Accordingly, effects of remote work on workplace productivity can be more accurately predicted.

In addition to improving accuracy of analysis of workplace productivity as it relates to remote work, embodiments described herein enable customized data analysis related to remote work in an automated and dynamic manner. That is, instead of manually gathering and analyzing data related to remote work, embodiments described herein enable a user (e.g., a business decision maker, team manager, or the like) to efficiently view remote work impact as desired by the user. In this regard, a user may specify (e.g., via a graphical user interface) productivity parameters for use in generating productivity data related to remote work. Various parameters selected or input by a user to define a scope of desired productivity data may include, for examples, worker parameters (e.g., attributes of workers desired for a productivity analysis), time parameters (e.g., before and/or after date or data range for a productivity analysis), and/or metric parameters (e.g., desired type or aspect of productivity for a productivity analysis). Based on various parameters selected or input by a user, a set of corresponding worker data can be obtained and used, via a difference-in-differences model, to determine a treatment effect (e.g., effect of remote work) in relation to the desired user-specified productivity parameters. By way of example only, assume a user desires to view differences in the impact of remote work among a sales team as compared to a software engineering team. In such a case, a user may specify a desire to compare remote work impacts related to a particular metric(s) (e.g., collaboration) for a sales role versus a software engineering role. Based on the input, a remote work effect associated with individuals having a sales role may be determined, and a remote work effect associated with individuals having a software engineering role may be determined. Such remote work effects may be presented to the user such that the user can view a difference in impacts between workers in a sales role versus a software engineering role. Remote work effects (e.g., generated via a difference-in-differences approach) may be used to provide workplace analytics to a user in any number of ways, some of which are described in more detail herein. Tailoring desired productivity data in relation to remote work effects, as described herein, enables users to view data relevant to the user in an efficient and accurate manner.

Although treatment group and control group may be referred to herein, as can be appreciated, such groups or sets of workers need not be affiliated with an experiment. Instead, such a remote work effect analysis can be performed using preexisting groups of workers. As such, a control group does not need to be formed, for example, to randomly assign some individuals to work from home pre-treatment. Instead, individuals that already worked from home, for example pre-COVID-19, can be used as a control group.

### Overview of Exemplary Environments for Enhancing Remote Work Productivity Data

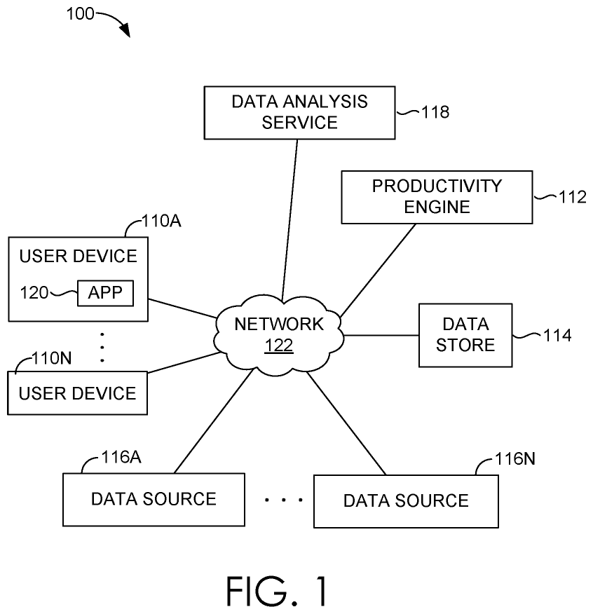

Referring initially to FIG. 1, a block diagram of an exemplary network environment 100 suitable for use in implementing embodiments described herein is shown. Generally, the system 100 illustrates an environment suitable for facilitating enhancement or improvement of generating and/or providing remote work productivity data. Among other things, embodiments described herein effectively and accurately determine productivity data related to remote work. Generally, remote work refers to consistently performing work in a location that is remote from an office location associated with an organization of a worker. Remote work may also be referred to as working from home or telecommuting. Productivity data is broadly used herein and may refer to any data associated with productivity of an organization, a team, an organizational group, an individual, or the like. As such, and as described further below, productivity data may relate to collaboration, use of technology, and/or other metrics related to productivity.

The network environment 100 includes user devices 110a-110n (referred to generally as user device(s) 110), a productivity engine 112, a data store 114, data sources 116a-116n (referred to generally as data source(s) 116), and a data analysis service 118. The user device(s) 110a-110n, the productivity engine 112, the data store 114, the data sources 116a-116n, and the data analysis service 118 can communicate through a network 122, which may include any number of networks such as, for example, a local area network (LAN), a wide area network (WAN), the Internet, a cellular network, a peer-to-peer (P2P) network, a mobile network, or a combination of networks.

The network environment 100 shown in FIG. 1 is an example of one suitable network environment and is not intended to suggest any limitation as to the scope of use or functionality of embodiments disclosed throughout this document. Neither should the exemplary network environment 100 be interpreted as having any dependency or requirement related to any single component or combination of components illustrated therein. For example, the user device 110a-110n and data sources 116a-116n may be in communication with the productivity engine 112 via a mobile network or the Internet, and the productivity engine 112 may be in communication with data store 114 via a local area network. Further, although the environment 100 is illustrated with a network, one or more of the components may directly communicate with one another, for example, via HDMI (high-definition multimedia interface), and DVI (digital visual interface). Alternatively, one or more components may be integrated with one another, for example, at least a portion of the productivity engine 112 and/or data store 114 may be integrated with the user device 110 and/or data analysis service 118. For instance, a portion of the productivity engine 112 may be integrated with a server (e.g., data analysis service) in communication with a user device, while another portion of the productivity engine 112 may be integrated with the user device (e.g., via application 120).

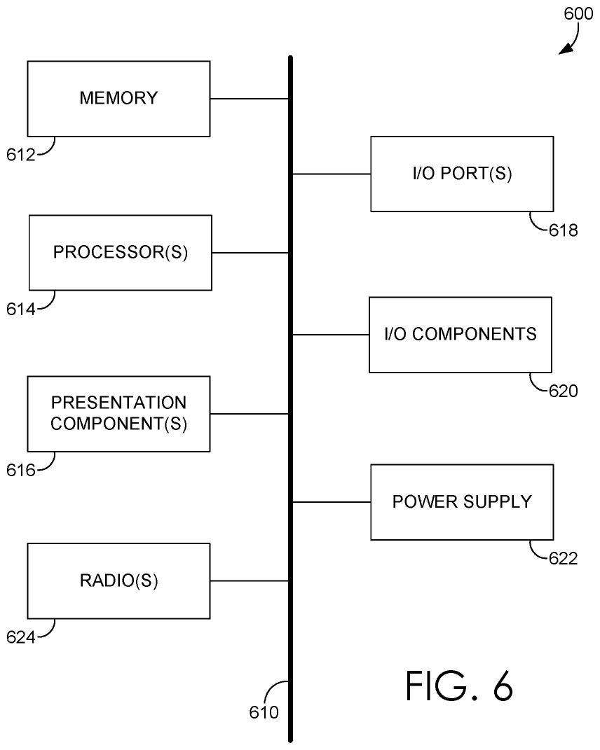

The user device 110 can be any kind of computing device capable of facilitating determining and/or providing productivity data. For example, in an embodiment, the user device 110 can be a computing device such as computing device 600, as described above with reference to FIG. 6. In embodiments, the user device 110 can be a personal computer (PC), a laptop computer, a workstation, a mobile computing device, a PDA, a cell phone, or the like.

The user device can include one or more processors, and one or more computer-readable media. The computer-readable media may include computer-readable instructions executable by the one or more processors. The instructions may be embodied by one or more applications, such as application 120 shown in FIG. 1. The application(s) may generally be any application capable of facilitating determining and/or providing productivity data. In some implementations, the application(s) comprises a web application, which can run in a web browser, and could be hosted at least partially server-side (e.g., via data analysis service 118). In addition, or instead, the application(s) can comprise a dedicated application. In some cases, the application is integrated into the operating system (e.g., as a service). As one specific example application, application or service 120 may be a business intelligence tool or other data analysis tool that provides various data and data visualizations. Such an application may be accessed via a mobile application, a web application, or the like.

User device 110 can be a client device on a client-side of operating environment 100, while productivity engine 112 and/or data analysis service 118 can be on a server-side of operating environment 100. Productivity engine 112 and/or data analysis service 118 may comprise server-side software designed to work in conjunction with client-side software on user device 110 so as to implement any combination of the features and functionalities discussed in the present disclosure. An example of such client-side software is application (or service) 120 on user device 110. This division of operating environment 100 is provided to illustrate one example of a suitable environment, and it is noted there is no requirement for each implementation that any combination of user device 110, productivity engine 112, and/or data analysis service 118 to remain as separate entities.

In an embodiment, the user device 110 is separate and distinct from the productivity engine 112, the data store 114, the data sources 116, and the data analysis service 118 illustrated in FIG. 1. In another embodiment, the user device 110 is integrated with one or more illustrated components. For instance, the user device 110 may incorporate functionality described in relation to the productivity engine 112. For clarity of explanation, embodiments are described herein in which the user device 110, the productivity engine 112, the data store 114, the data sources 116, and the data analysis service 118 are separate, while understanding that this may not be the case in various configurations contemplated.

As described, a user device, such as user device 110, can facilitate determining and/or providing productivity data. Productivity data is broadly used herein and may refer to any data associated with productivity associated with a workplace. In embodiments, productivity data refers to productivity associated with a workplace in relation to remote work. For instance, productivity data may correspond with remote work as it relates to an organization, a team, an organizational group, an individual, or the like. Productivity data may relate to various aspects of workplace collaboration (e.g., meetings, messaging, email, shared documents, focused time, or the like), use of technology (e.g., access of particular programs or applications, documents; encountered errors; use of hardware; or the like), and/or other aspects of productivity. As described herein, productivity data includes an effect of remote work as it pertains to a metric (e.g., a collaboration metric).

A user device 110, as described herein, is generally operated by an individual or entity interested in viewing productivity data related to a workplace. In some cases, such an individual may be a worker of an organization for which data is captured. In other cases, such an individual may be a team manager, an organization decision maker, a human resources employee, or the like. As can be appreciated, a user interested in viewing productivity data related to a workplace need not be an employee, member, or owner of the workplace. For example, in some cases, a user desiring to view productivity data may be an individual gathering insights of remote work effects across an industry.

In some cases, determination or provision of productivity data may be initiated at the user device 110. For example, in some cases, a user may select an option or setting indicating to determine productivity data related to an individual, a team, an organization, or the like. As can be appreciated, in some cases, a user of the user device 110 that may initiate determining and/or providing of productivity data is a user that can view productivity data. In additional or alternative cases, an administrator, programmer, or other individual associated with an organization may initiate identification of productivity data, but not necessarily be a consumer or viewer of the productivity data. By way of example only, an individual associated with the data analysis service 118 may provide input, as described more fully below, to provide productivity parameters.

Determining and/or providing productivity data may be initiated and/or presented via an application (or service) 120 operating on the user device 110. In this regard, the user device 110, via an application and/or service 120, might allow a user to initiate a determination or presentation of productivity data. The user device 110 can include any type of application and may be a stand-alone application, a mobile application, a web application, or the like. In some cases, the functionality described herein may be integrated directly with an application or may be an add-on, or plug-in, to an application. Examples of applications that may be used to initiate and/or present productivity data include Workplace Analytics, Power Apps, and/or Power BI provided by Microsoft®.

Such determination and/or provision of productivity data may be initiated at the user device 110 in any manner. For instance, upon accessing a particular application (e.g., a business analytics application), a user may be presented with, or navigate to, options associated with productivity data, such as productivity data related to remote work. In such a case, a user may be presented with one or more productivity parameter options. In other cases, a user may be presented with a query input tool in which productivity parameters may be input. Various productivity parameter options for which a user may provide an input or selection may be related to a target worker set(s), a control worker set(s), a time period(s), a metric(s), and/or the like.

As one example, a user may specify a productivity parameter(s) related to a target worker set, a time period, and/or a metric of interest for providing productivity data. Such productivity parameters can be selected in any number of ways. For instance, a user may be presented with an adjustable control (e.g., slider), a drop down menu, or a list that enables the user to specify a parameter for determining productivity data. As can be appreciated, a user may select or input any number of parameters to generate and/or view results related to a particular productivity analysis or set of productivity analyses. For instance, a user may specify multiple worker set parameters defining worker sets (e.g., a role, a demographic, and a worker status), multiple time parameters (e.g., April-July 2020), and/or multiple metric parameters (e.g., meeting parameter and focused time parameter). Additionally or alternatively, a user may select parameters associated with multiple productivity analyses. For instance, a user may provide one set of inputs or selections that includes productivity parameters related to managers across an organization that have children, and a second set of input or selections that includes productivity parameters related to managers across the organization that do not have children. As another example, a user may provide a first set of inputs that includes productivity parameters related to software engineer productivity measurements and a second set of inputs of productivity parameters that relate to software engineer collaboration measurements.

The user device 110 can communicate with the productivity engine 112 to provide productivity parameters, initiate determination of productivity data, and/or obtain productivity data. In embodiments, for example, a user may utilize the user device 110 to initiate a determination of productivity data via the network 122. For instance, in some embodiments, the network 122 might be the Internet, and the user device 110 interacts with the productivity engine 112 (e.g., directly or via data analysis service 118) to initiate generation of productivity data. In other embodiments, for example, the network 122 might be an enterprise network associated with an organization. It should be apparent to those having skill in the relevant arts that any number of other implementation scenarios may be possible as well.

With continued reference to FIG. 1, the productivity engine 112 can be implemented as server systems, program modules, virtual machines, components of a server or servers, networks, and the like. At a high level, the productivity engine 112 manages productivity related to remote work. In particular, the productivity engine 112 can obtain productivity parameters, such as parameters from user devices 110, and worker data, such as worker data from data sources 116. Data sources 116a-116n may be any type of source providing data (e.g., worker data). Generally, the productivity engine 112 can receive productivity parameters and/or worker data from any number of devices. As such, the productivity engine 112 can identify and/or collect data from various user devices, such as user devices 110a-110n, and sources, such as data sources 116a-116n. In this regard, the productivity engine 112 can retrieve or receive data collected or identified at various components, or sensors associated therewith.

As described, in some cases, the productivity engine 112 can receive productivity parameters for determining productivity data via the user device 110 (or other device). Productivity parameters received from a device, such as user device 110, can include parameters that were manually or explicitly input by the user (input queries or selections) as well as parameters that were automatically generated. Generally, the productivity engine 112 can receive productivity parameters from any number of devices. In accordance with receiving a productivity parameter (e.g., via the user device 110), the productivity engine 112 can access and utilize worker data to determine a productivity data. As described, in various embodiments, a user-provided productivity parameter(s) is not required. For example, default productivity parameters (e.g., a default date parameter, a default set of metrics, and/or a default worker set) can be used to generate productivity data.

In accordance with productivity parameters, the productivity engine 112 can use worker data to determine productivity data in relation to remote work. Worker data generally refers to any data related to one or more workers, generally associated with a particular company or organization. A worker, for example, may be an employee or contractor of an organization (e.g., a company). Worker data may be any type of data associated with a worker, such as worker interactions, worker activities, and the like. By way of example and not limitation, worker data may include data that is sensed or determined from one or more sensors, such as location information of mobile device(s), smartphone data (such as phone state, charging data, date/time, or other information derived from a smartphone), worker-activity information (for example: app usage; online activity; searches; browsing certain types of webpages; listening to music; taking pictures; voice data such as automatic speech recognition; activity logs; communications data including calls, texts, instant messages, and emails; web site posts; other user data associated with communication events; other worker interactions with a user device) including worker activity that occurs over more than one worker device, worker history, session logs, application data, contacts data, calendar and schedule data, notification data, social network data, news (including popular or trending items on search engines or social networks), online gaming data, ecommerce activity, and nearly any other source of data that may be sensed or determined as described herein.

As can be appreciated, in embodiments, a worker may be able to opt in or out of any access or utilization of worker data to determine productivity data. Additionally or alternatively, a worker and/or user may be able to view or modify (e.g., correct) worker data and/or productivity data. In some cases, worker data might be anonymized. Further, some implementations may only provide productivity data for groups having a minimum number of individuals so as not to be able to identify particular individuals. Other methods of anonymization and privacy in relation to worker data and/or productivity data may also be used in various implementations.

Such worker data can be initially collected at remote locations or systems and transmitted to data store 114 for access by productivity engine 112. In accordance with embodiments described herein, worker data collection may occur at data sources 116. In some cases, data sources 116, or portion thereof, may be worker devices, that is, computing devices operated by a worker. As such, worker devices, or components associated therewith, can be used to collect various types of worker data. For example, in some embodiments, worker data may be obtained and collected at a worker device via one or more sensors, which may be on or associated with one or more worker devices and/or other computing devices. As used herein, a sensor may include a function, routine, component, or combination thereof for sensing, detecting, or otherwise obtaining information, such as worker data, and may be embodied as hardware, software, or both.

In addition or in the alternative to data sources 116 including worker devices, data sources 116 may include servers, data stores, or other components that collect worker data, for example, from worker devices. For example, in interacting with a worker device, data or usage logs may be captured at data sources 116 and, thereafter, such worker data can be provided to the data store 114 and/or productivity engine 112. Although generally discussed as worker data provided to the data store 114 and/or productivity engine 112 via data sources 116 (e.g., a worker device or server, data store, or other component in communication with worker device), worker data may additionally or alternatively be obtained at and provided from the data analysis service 118, or other external server, for example, that collects data based on worker interactions with worker devices. Worker data can be obtained at a data source periodically or in an ongoing manner (or at any time) and provided to the data store 114 and/or productivity engine 112 to facilitate enhancement of identifying productivity data.

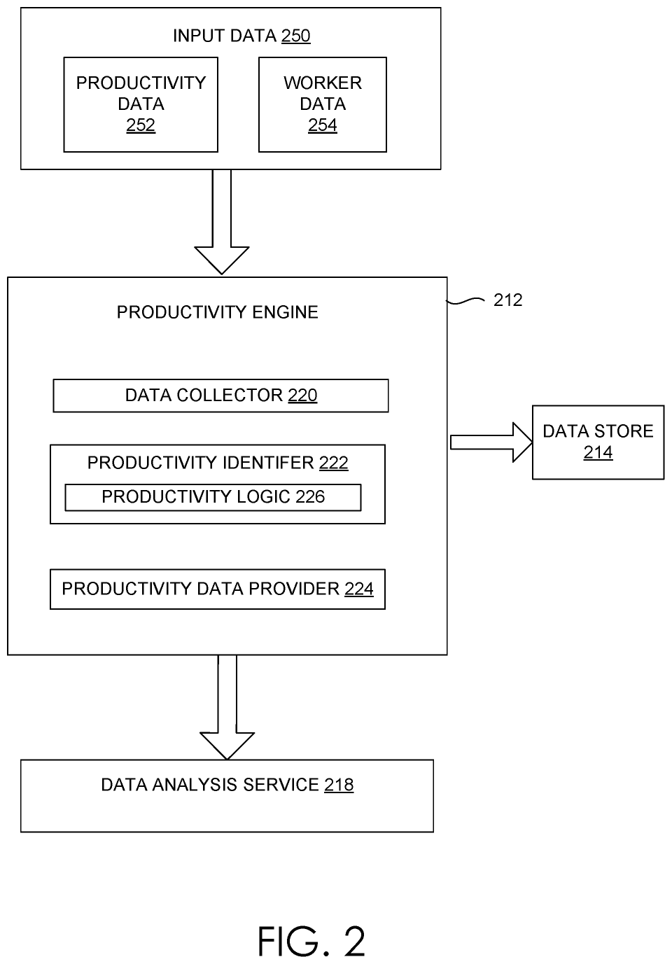

In accordance with embodiments described herein, and as more fully described below with reference to FIG. 2, the productivity engine 112 may utilize a difference-in-differences approach to determine productivity data. In particular, in accordance with initiating a productivity analysis in relation to remote work (e.g., based on reception of a production parameters), the productivity engine 112 can obtain appropriate worker data to analyze. As described herein, the specific worker data for use in determining productivity data can depend on productivity parameters (e.g., specified by a user) such that the productivity data provides productivity information desired by the user.

Upon obtaining appropriate worker data, difference-in-differences can be used to identify relevant productivity data. In particular, utilizing a difference-in-differences approach, an effect of remote work in relation to a productivity parameter set can be determined. An effect of remote work, or remote work effect (also sometimes referred to as a treatment effect), generally refers to a difference between an observed outcome(s) and a normal outcome(s) of a treatment group after an occurrence of the treatment. In embodiments discussed herein, a treatment refers to the transition to remote work (e.g., as occurred during COVID-19 work from home mandates for various organizations). A normal outcome for the treatment group after an occurrence of the treatment corresponds with a normal difference in the outcome variable between the treatment group and the control group that would exist if neither group experienced the treatment.

In some cases, the effect of remote work can be provided to the user device 110 for display to the user. In other cases, the data analysis service 118 may use such data to perform further productivity analysis and/or provide productivity data to the user device 110. In some embodiments, the data analysis service 118 can reference the productivity data, such as an effect(s) of remote work, and use such data to perform further productivity analysis (e.g., generate additional productivity data) and/or provide productivity data to the user device 110. The data analysis service 118 may be any type of server or service that can analyze data and/or provide information to user devices. One example data analysis service 118 includes a business intelligence service, such as Power BI, by Microsoft®, that can provide various data visualizations for presentation to users. Although data analysis service 118 is shown separate from the productivity engine 112, as can be appreciated, the productivity engine can be integrated with the data analysis service 118, or other service or service. The user device 110 can present received data or information in any number of ways, and is not intended to be limited herein. As an example, information based on productivity data can be presented via application 120 of the user device.

As described, in some cases, the data analysis service 118 may use an effect of remote work determined via a difference-in-differences approach to further analyze productivity. Such a remote work effect may be used in any number of ways and is not intended to be limited to examples provided herein. For example, in one implementation, a remote work effect may be presented among other productivity data (e.g., related to remote work or unrelated to remote work). In another implementation, a remote work effect may be used to generate a productivity score for an organization, or a portion thereof (e.g., a team, a group, an individual, or the like). In yet another implementation, multiple remote work effects may be obtained and visually presented as a comparison (e.g., via a chart, graph, or other comparison of data). In such an implementation, a user may view similarities and/or differences among remote work effects across worker sets, dates, and/or metrics (e.g., a sales team versus a software engineering team; May of 2020 versus December of 2020; team meetings versus focus time). In another implementation, remote work effects may be used to generate insights related to remote work (e.g., a suggested schedule/calendar of events for a worker or team, a suggested technology, or the like).

Advantageously, utilizing implementations described herein enable generation of productivity data related to remote work to be performed in an efficient and more accurate manner. Further, the generated productivity data can dynamically adapt to align with information desired by the user. As such, a user can view desired information and can assess the information accordingly.

Turning now to FIG. 2, FIG. 2 illustrates an example implementation for enhancing remote work productivity data, via productivity engine 212. The productivity engine 212 and/or data analysis service 218 can communicate with the data store 214. The data store 214 is configured to store various types of information accessible by the productivity engine 212 and/or a data analysis service 218, or other server. In embodiments, data sources (such as data sources 116 of FIG. 1), user devices (such as user devices 110 of FIG. 1), productivity engine 212, and/or data analysis service 218 can provide data to the data store 214 for storage, which may be retrieved or referenced by any such component. As such, the data store 214 may store productivity parameters, productivity data, worker data, or the like.

In operation, the productivity engine 212 is generally configured to manage determination and/or provision of productivity data (e.g., remote work effect). In embodiments, the productivity engine 212 includes a data collector 220, a productivity identifier 222, and a productivity data provider 224. Some embodiments of productivity engine 212 may also utilize productivity logic 226, as described herein. According to embodiments described herein, the productivity engine 212 can include any number of other components not illustrated. In some embodiments, one or more of the illustrated components 220, 222, and 224 can be integrated into a single component or can be divided into a number of different components. Components 220, 222, and 224 can be implemented on any number of machines and can be integrated, as desired, with any number of other functionalities or services.

The data collector 220 can receive or obtain input from various components for utilization in determining productivity data. The data collector 220 can obtain input data 250, which can include productivity parameters 252 and worker data 254. Such data can be received from any number of devices or components. For example, productivity parameters 252 may be received from various user devices, and worker data 254 may be received from various data sources (e.g., worker devices, data store, server, or the like).

As described, productivity parameters may be obtained by the data collector 220. In this regard, the data collector 220 may obtain productivity parameters from user devices. Such parameters may indicate a manner and/or an extent in which to tailor productivity determinations. For example, a user may prefer to view productivity data associated with a particular team within an organization, a particular demographic within an organization, a particular role or position within an organization, or the like. As previously described, productivity parameters may be provided by a user device operated by a user viewing data or a user device operated by an individual managing workplace analytics on behalf of an entity (e.g., company). Any productivity parameters may be stored, for instance, at data store 214.

Examples of productivity parameters that may be input or selected by a user may include, for example, worker set parameter(s), a date parameter (s), a metric parameter(s), or the like. A worker set parameter generally refers to an indication of a particular set of workers for which productivity analysis is desired. A worker set parameter may be provided to indicate a target worker set (i.e., a treatment group) and/or a control worker set (i.e., a control group). A target worker set refers to a set of workers for which productivity data is determined. A control worker set refers to a set of workers used as a baseline or a control to determine productivity data for the target worker set. As such, in some implementations, a user may specify whether worker set parameters are associated with a target worker set and/or control worker set. In other implementations, a user may provide one set of worker set parameters that is automatically applied (e.g., to the target worker set and/or control worker set).

In some embodiments, a work set parameter may include a specific list of individual workers to include in a worker set (e.g., target worker set), such as, for example, worker A, worker B, worker C, and worker D. In other embodiments, a worker set parameter may include an attribute or parameter associated with workers. Such worker set parameters may include, for example and without limitation, an indication of an organization level(s), organization role(s), demographic(s), business unit(s), geography(s), worker status(s), or the like. An organization level parameter generally refers to a parameter indicating whether an analysis of an organization, a team, or an individual is desired. In some cases, particular workers may be specified (e.g., the members of a particular team or a specific individual). An organization role parameter generally refers to any parameter indicating a role or position within an organization. An organization role may specify a level of work (e.g., manager, supervisor, vice-president, president, staff, management, and the like) and/or a type of work (e.g., software engineer, sales, assistant, business, legal, and the like).

A demographic parameter may be any parameter indicating a demographic, such as age, gender, number of children, age of children, or the like. A business unit parameter generally refers to any parameter indicating a particular business area in which a worker(s) works. A geography parameter generally refers to any parameter indicating a geographical location. A geographical location may be provided in any number of levels, such as a city, a state, a country, rural/urban, or the like. A worker status parameter may refer to any parameter indicating any status associated with a worker, such as for example, a full time employee, part-time employee, contract worker, or the like. As can be appreciated, other parameter types may be specified or provided to indicate a desired focus of productivity data.

In addition to worker set parameters, date parameters and/or metric parameters can be obtained. As described herein, productivity may be determined based on a comparison of workers over time (e.g., from one date to another date). As such, a user may provide a date(s) preference for use in determining productivity. For example, a user may select a comparison of worker data from February to worker data from April. As another example, a user may select a comparison of worker data from January to worker data from May. Such date parameters may be provided in any of a number of ways (e.g., via a drop down menu, slider scale, or the like).

Metric parameters generally refer to any type of productivity metric or outcome desired to be measured or scored. In embodiments, a metric parameter indicates a productivity metric related to remote work for which productivity data is desired. Examples of productivity metrics may include technology metrics, collaboration metrics, and the like. Collaboration-related metrics may include any metric related to collaboration. Collaboration-related metrics may include, for example, focus hours (e.g., total number of hours with two or more-hour blocks of time during which a worker did not have meetings), email hours (e.g., total number of hours a worker spent sending and receiving emails), message hours (e.g., total number of hours a worker spent in instant messages with at least one other person), meeting hours (e.g., total number of hours a worker spent in meetings with at least one other person), collaboration hours (e.g., email hours+message hours+meeting hours), and document collaboration hours (e.g., time spent on document collaboration). Technology-related metrics may include any metric related to technology. Technology-related metrics may include, for example, hardware usage, software usage, application-specific usage, multiple platform usage, content storage usage (e.g., location of content storage), internal/external document sharing, error troubleshooting, network performance, or the like.

A user may indicate any number of productivity parameters for determining productivity. For example, in some cases, a user may specify various worker set parameters of a desired target worker set (e.g., a demographic and a role) and a set of metric parameters for which productivity data is desired. As another example, a user may specify various parameter sets for comparison purposes. For example, a user may desire to view productivity data associated with a productivity metric (e.g., collaboration) as it applies to the organization as a whole, a team, and each individual of the team. The user may further desire to view productivity related to team individuals that have young children as compared to team individuals that do not have young children.

Although generally described as obtaining productivity parameters indicated by a user, in some cases, a set of productivity parameters may alternatively or additionally be automatically determined (e.g., default or dynamically determined). For example, a user may specify a target worker set, but a date parameter(s) and metric parameter(s) may be automatically selected or determined. For instance, a data parameter may be a default parameter, such as a time period between February 2020 and April 2020, and a metric parameter may be automatically determined based on the target worker set (e.g., a first metric set may correspond with an organization target worker set and a second metric set may correspond with an individual target worker set).

Based on a set of productivity parameters, a set of worker data can be obtained by the data collector 220. In embodiments, the data collector 220 can obtain worker data that corresponds with a worker set parameter(s), a data parameter(s), and/or a metric parameter(s). As described, such worker data may include various types of data that indicate information about a worker and/or worker device. For example, worker data may indicate various worker interactions, worker activity, worker device information, worker information, worker preferences, and the like. In this regard, worker data can include information indicating worker patterns, such as what data worker are accessing or viewing and at what times.

Such worker data can be accessed via data store 214, which may obtain data from any number of devices, including data sources such as worker devices or application servers. For example, a worker device used by a worker may capture worker data in any number of ways, including utilization of sensors that capture information. As another example, a server (e.g., application server) in communication with a worker device may gather log or usage data associated with usage of a worker device, or portion thereof. Although described as accessing worker data from data store 214, worker data can alternatively or additionally be obtained from other components, such as, for example, directly from worker devices or application servers in communication with worker devices, another data store, or the like.

In some cases, the worker data may be processed prior to being received at the data store 214. Additionally or alternatively, the data may be processed at the data store 214 or other component, such as data collector 220 (e.g., to identify outcomes). In this regard, the data store 214 may store raw data and/or processed data. For example, data logs may be mined to identify amounts of worker time that correspond to various metrics. As one example, assume collaboration metrics, including meeting time, focused time, email time, and messaging times, are options available for performing productivity analysis. In such a case, log data may be analyzed for each of a number of workers to identify an amount of time each worker spent in association with meeting time, focused time, email time, and messaging time. Such data can be stored in the data store (e.g., via an index or lookup system) for subsequent utilization by the productivity engine 212.

As can be appreciated, the data collector 220 can collect worker data (e.g., via the data store 214) associated with a target worker set and a control worker set. As described, the target worker set generally refers to a set of workers for which productivity data is desired to be determined. For instance, in cases that a user desires to view productivity data for the entire organization, the target worker set includes each worker of the organization. In cases that a user desires to view productivity data for a particular team, the target worker set includes each worker of the team.

As such, in some cases, worker set parameters may be used to determine which worker data to obtain for performing productivity analysis. As described, in some cases, individual workers may be specified, for example, by a user, such that worker data associated with the specific individual workers may be accessed. In other cases, worker data to obtain may be determined based on the specific worker set parameter(s). For example, assume individuals on a team are identified for determining productivity data. In such a case, the data collector 220 may obtain worker data associated with workers on the particular team.

To identify workers that correspond with a worker set parameter(s), in some cases, the data collector 220 may access an index or lookup system to identify workers for which productivity data is determined. Such an index or lookup system may be stored in association with the data store 214. By way of example only, a hierarchical organizational structure, an address book, a directory, or other data structures (e.g., human resources documentation) may be accessed to identify workers associated with the particular worker set parameter (e.g., a demographic, geography, role, or the like). Upon identifying the workers, worker data associated with such workers can be accessed or obtained.

Such a process to identify worker data associated with worker set parameters can be used to determine worker data for a target worker set and/or a control worker set. As such, workers associated with the target worker set and the control worker set can be identified and used to obtain corresponding worker data.

In addition, the data collector 220 may identify workers that belong to the control worker set. As described, the control worker set is used as a baseline for evaluating the productivity of the target worker set. Generally, in embodiments described herein, the control worker set performed remote work prior to the treatment of remote work (e.g., in association with COVID-19). In some embodiments, the control worker set includes workers that have the same attributes as specified via the productivity parameters. For instance, if productivity data associated with a particular team is desired, members of the team that worked from home prior to the treatment date may be identified. In some embodiments, workers that correspond with a particular worker set parameter(s) can be identified and, thereafter, filtered to form a control worker set based on whether the workers are considered remote workers. Although workers in the control worker set and target worker set may satisfy the same worker set parameters, that need not be the case. For example, a target worker set of a particular team may be used, but the control group may include all individuals at the organization that performed remote work prior to the treatment date.

Determining workers that work remotely (e.g., prior to a treatment date, such as COVID-19 mandates) for use in the control worker set can be performed in any number of ways. In one embodiment, human resources data can be used to determine whether an individual works from home. For instance, an organizational directory may specify a location (e.g., building, office) assigned to a worker. In cases that a worker works remotely, his or her location may be labeled in a particular way, such as “home office” or “mobile worker.”

In another embodiment, collaboration time and techniques may be analyzed to infer whether workers are remote workers. For instance, assessing a proportion of coworkers that reside in the same general vicinity or proportion that live in different locations. Other methods for identifying workers that perform remote work may include use of Internet Protocol (IP) usage data. For example, as workers access and use a network, such IP data can be captured and analyzed (e.g., via reverse engineering) to determine if the IP address is associated with the organization, or another location (e.g., a home). Yet other methods to infer remote workers include analyzing behavior signals, such as whether workers joining meetings from online or in-person. For instance, workers that consistently join meetings using remote collaboration software may be identified as remote workers.

In some cases, the manner or method to use for identifying or inferring which workers are remote workers (e.g., for purposes of determining workers in a control group) may be specified during implementation, or based on a user preference (e.g., a user-provided parameter). In other cases, identifying or inferring remote workers may follow a tiered approach or a combination of approaches. For example, a first approach applied to identify or infer a list of remote workers may be based on an organization directory, but analysis of collaboration and/or IP usage may be employed to supplement the list (e.g., to identify workers that substantially perform remote work but not formally designated as remote workers).

Although generally described herein as obtaining worker data in association with workers of a particular organization, as can be appreciated, some implementations may analyze worker data associated with workers across organizations. For example, a user (e.g., a researcher or data analyst) may select multiple organizations across which to analyze data.

In addition to obtaining worker data for a particular set of workers, the data collector 220 may also obtain worker data in accordance with date and/or metric parameters. With regard to a date(s) parameter, worker data associated with specified dates can be obtained. Generally, in accordance with implementations utilizing a difference-in-differences approach, worker data is obtained in association with a pre-treatment date (e.g., prior to remote work mandate due to COVID-19) and a post-treatment date (e.g., after the remote work mandate due to COVID-19). Such date ranges may be any dates before or after a treatment date, or a particular set of dates. For instance, in some cases, any worker data corresponding with a date before March 2020 and any worker data corresponding with a date after March 2020 may be used as pre-treatment and post-treatment data. In another case, a user may specify a parameter of June 2020 as a desired data for productivity analysis. In such a case, worker data corresponding with a date before March 2020 may be used as pre-treatment data, and worker data corresponding with a date in June 2020 may be used as post-treatment data. As can be appreciated, identifying worker data associated with particular dates can be performed using any method, such as timestamp analysis.

With regard to a metric(s) parameter, worker data associated with specified metrics to be analyzed can be obtained. By way of example only, assume a user selects to view collaboration-related metrics. In such a case, worker data associated with such collaboration metrics may be accessed for identified workers in connection with the pre-treatment date and the post-treatment date. As can be appreciated, in embodiments, the data collector 220, or another component, may determine which data is relevant to a particular metric. In some cases, such associations may be determined and stored, for example, in an index or lookup system. For instance, log or usage data may be analyzed to identify amounts of time associated with different aspects of collaboration, technology use, or the like for various workers. Such amounts of time can then be stored (e.g., in association with the corresponding worker), for instance in data store 214, for subsequent access when specific metrics are desired for productivity analysis. In other cases, such associations may be dynamically determined using a search query or some other method to identify data related to a particular metric.

The productivity identifier 222 is generally configured to determine productivity data. In particular, the productivity identifier 222 can determine productivity data in association with a target worker set. As described herein, to more accurately determine productivity data, embodiments described herein include use of a difference-in-differences approach. Generally, difference-in-differences is a causal identification strategy used, in the present techniques, to control for unobserved confounding factors in estimating the causal effect of remote working. As described, a comparison of outcomes associated with individuals previously working in an office as compared to the individuals later working from home (e.g., due to COVID-19) is unlikely to generate credible causal estimates associated with remote work. In this regard, because of the confounding factors caused by the COVID-19 pandemic, remote work effects are not accurately inferred from pure observational changes measured before and after COVID-19.

As such, a difference-in-differences approach can be used to analyze productivity, and specifically a remote work effect, based on a difference in changes over time between workers working remotely prior to a treatment date (e.g., COVID-19 remote work mandate) and workers that worked in the office prior to the treatment date. Using a difference-in-differences approach enables isolation of the effect of transitioning to remote work from other factors, such as pandemic-related factors and non-pandemic-related factors (e.g., business cycles, seasonality, personal changes, and the like). Generally, and at a high level, any changes in the behavior of workers already working from home prior to COVID-19 are due to other factors beyond the remote work transition. On the other hand, any changes in the behavior of workers working in the office prior to COVID-19 are due to both the remote work transition and other factors. Assuming the trends are parallel (e.g., the time series for the control and treatment groups would have moved in parallel absent COVID-19) and, in some cases further assuming that at least after conditioning on the covariates such as role and seniority, the non-remote effects are equal for both groups (e.g., the non-remote effects of COVID-19 on average are the same or similar for workers previously working from home and workers previously working in an office), taking the difference enables isolation of the effect of remote work. As such, difference-in-differences framework enables separation of the causal impact of remote work from differences between worker sets and over time.

Generally, a difference-in-differences framework assumes that the outcome y for person i belonging to group g at time t, y_{igt}, can be modeled as:

y_{igt}=γ_{g}+λₜ+δ·d_{gt}+ε_{igt}, Equation 1

where γ_{g} is a group-level fixed effect that accounts for time-invariant differences between groups, λₜ is a time fixed effect that accounts for any temporal trends that affect all groups in the same way, d_{gt} indicates whether or not group g has been treated at time t, and ε_{tgt} is a residual with E(ε_{igt}|g,t)=0. The treatment effect (remote work effect), δ, is causally identified so long as the model accurately represents the data generating process. That is, λₜ captures a time effect (e.g. COVID or seasonality) that applies to both the treatment and control group in each time period, such that the expected average outcome for the group would have been γ_{g}+λₜ if the treatment group had not been treated at time t.

In embodiments, the more general difference-in-differences model can use additional covariates to control for various attributes. In this way, the difference-in-difference model can include any number of covariates to facilitate removal of deterministic variation. Utilizing covariates to control for various attributes or factors can provide a more robust model with respect to deviations from the “parallel trends” assumption and increases the precision of the estimates. As such, resulting effects of remote work, denoted by δ, can be more accurately predicted. One example augmented model, which includes additional covariates to control for job roles and management status (e.g., whether a worker is a manager), can be represented as:

y_{igt}=γ_{g}+λ· [symbol] (t=post COVID)+αᵣₒₗₑ₍ᵢ₎+β· [symbol] (i is manager)+δ· [symbol] (g=P-OFC)· [symbol] (t=post COVID)+ε_{igt} Equation 2

where αᵣₒₗₑ₍ᵢ₎ denotes a role-specific fixed effect, β denotes a fixed effect for managers, [symbol] (x)=1 if x is true, and P-OFC reflects workers working in the office prior to COVID. Although data can be observed from many time periods both pre- and post-COVID-19, data can be aggregated for each worker into one “pre-treatment” observation and one “post-treatment” observation to address potential autocorrelation. Standard errors can also be clustered at the level of employee manager, that is, workers who report to the same manager are in the same “cluster.”

As the extent to which workers had previously been exposed to remote work may impact the remote work experience, in some cases, the difference-in-differences model can allow for the remote work effect to vary for workers with different levels of prior remote collaboration experience. For example, an augmented model may account for workers that had less remote collaboration experience and those that had more remote collaboration experience using two subgroups of the treatment group, such that treatment effects δ_{L} and δ_{M} can be estimated for each of the subgroups.

Although the above augmented difference-in-differences model (Equation 2) includes covariates to control for job roles and management status, as can be appreciated, difference-in-differences models may be augmented to control for various attributes or factors. In some cases, the attributes for which to control may be specified by a user (e.g., a programmer, administrator, results viewer, or the like). Such preferences may be specified by a user to generally augment the model (e.g., during setup of productivity engine). In this regard, the difference-in-difference model may be augmented in advance of generally being used to identify remote work effects. For example, assume that in analyzing data, whether a worker is on paid time off (PTO) is identified as generating a deviation from the parallel trends assumption. In such a case, a covariate related to PTO may be specified by a user (e.g., programmer, administrator, or viewer) and, thereafter, used to augment the difference-in-differences model for subsequent executions of the model. In other cases, the attributes for which to control may be specified as a productivity parameter (i.e., a control parameter) indicated by a user in initiating determination of productive data, such as remote work effect. In such cases, the difference-in-differences model may be dynamically augmented for a particular performance of a productivity analysis based on a control parameter specified by a user (e.g., to control for a particular attribute).

In yet other cases, a variable for which to control in the difference-in-differences framework may be automatically identified. For example, based on an automated analysis of the data set(s) to be used in performing a productivity analysis, a variable(s) may be recognized that tends to generate a deviation from the “parallel trends.” In such a case, the recognized variable(s) can be used to automatically augment the difference-in-differences approach. Alternatively, the recognized variable(s) may be presented to a user for confirmation as to whether the user would like to include such a variable as a covariate in the model to facilitate removal of deterministic variation.

As described, the productivity identifier 222 can use various data to determine productivity data, such as remote work effects. Embodiments described herein provide examples of various combinations of data that can be used to determine productivity data, but are provided for illustrative purposes only. As can be appreciated, any combinations of data are contemplated within the scope for determining productivity data. Some embodiments of productivity identifier 222 utilize productivity logic 226 to determine productivity data.

Productivity logic 226 may include rules, conditions, associations, classification models, or other criteria, to identify or predict productivity data, such as remote work effects in conjunction with input data. For example, in one embodiment, productivity logic 226 may include a difference-in-differences model for predicting remote work effects, based on worker data. Productivity logic 226 may take different forms depending on the mechanism used to determine productivity data. For example, productivity logic 226 may comprise a statistical model, fuzzy logic, neural network, finite state machine, support vector machine, logistic regression, clustering, or machine-learning techniques, similar statistical classification processes, or combinations of these to identify productivity data, such as remote worker effects.

As described, in various implementations, worker data is used to identify or determine productivity data, such as remote work effects. In this way, a remote work effect (δ) can be predicted based on worker data. In implementation, productivity identifier 222 uses appropriate worker data (e.g., as identified via the data collector 220) in association with a differences-in-differences model to predict remote work effect in association with the target worker set. In some cases, a regression analysis may be performed to identify or learn remote work effects along with other coefficients of the difference-in-difference model.

Productivity data, such as remote work effects, can be represented in any number of ways. For example, productivity data can be represented as a time value (e.g., representing an amount of time), a percentage value, a text value (e.g., indicating an extent or level of effect, such as high/medium/low), or the like. By way of example only, assume remote work effect is determined for total collaboration. In such a case, the remote work effect can be represented as a measure of total hours (e.g., 5 hours per week) increased or decreased based on a transition to remote work. Alternatively or additionally, the remote work effect related to overall collaboration can be represented as a percentage increase or decrease (e.g., decrease of 5%). As such, the remote work effect can be expressed as a percentage of an average outcome (e.g., δ/y̅_{Feb}). For example, the remote work effect coefficient may be normalized by an average level of the outcome variable in a treatment group (e.g., target worker set) to give percent differences.

The productivity data provider 224 is generally configured to provide productivity data, such as remote work effects determined via productivity identifier 222. In some cases, the productivity data provider 224 may provide productivity data to a user device for presentation to a user. In such cases, the user may view the productivity data. Additionally or alternatively, the productivity data provider 224 may provide productivity data, for example, to the data store 214 and/or data analysis service 218. For example, a remote work effect associated with a target worker set can be provided to the data analysis service 218.

The data analysis service 218 can obtain any productivity data, such as an effect(s) of remote work, generated via the productivity engine 212. Generally, as described herein, the data analysis service 218 can use such data to perform further productivity analysis (e.g., generate additional productivity data) and/or provide productivity data to a user device. At a high-level, the data analysis service 218 may be any type of server or service that can analyze data and/or provide information to user devices (e.g., a business intelligence service).

In some embodiments, the data analysis service 118 can use remote work effects output via the productivity engine 212 to generate a visualization to present to the user. For instance, remote work effects may be presented in a graphical form or in a chart form to illustrate remote work effects over time. By way of example only, remote work effects for a particular target worker set may be presented for April through December 2020 to illustrate how remote work effects have changed throughout the year. In another example, remote work effects for different target worker sets and/or metrics may be presented to show how remote work effects correspond with the different target worker sets and/or metrics. For instance, remote work effects may be comparatively presented for a sales team and an engineering team. As another example, remote work effects may be comparatively presented for full-time employees versus part-time employees. Such visualizations may include presentation of the productivity parameters used to determine the productivity data. For example, attributes associated with the worker set, dates analyzed, and/or metrics analyzed may be presented via the graphical user interface.

Additionally or alternatively, remote work effects can be used to further analyze productivity. For example, in one implementation, a remote work effect may be used to generate a productivity score for an organization, a team, a group, an individual, or the like. Such a productivity score may be presented or otherwise used to provide information to a user (e.g., a decision maker, manager, human resources representative, or business strategist).

In yet another implementation, remote work effects may be used to generate insights related to remote work. For example, based on a remote work effects, relevant suggestions or recommendations can be identified and presented to a user. The insights or suggestions may be based on any number of factors. For example, in cases that remote work effects are relatively low or high may prompt a related insight to be generated. By way of example only, in cases that remote work effects indicate an increase in worker meetings, technology may be suggested to facilitate the meetings or a suggestion to block off time in a calendar for focus work may be provided.

Data analysis service 218 may use and generate productivity data in any number of ways. Further, data analysis service 218 may provide various data visualizations for presentation to users, only some of which are described herein. The particular utilization and/or visualizations implemented via a data analysis service 218 may be configured in any number of ways. In some cases, such use and/or generation of productivity data may be customized or specific to a consumer of the information (e.g., a user). For example, one organization that utilizes data analysis service 218 may configure use and/or generation of productivity data in one way, while another organization that utilizes data analysis service 218 may configure in another way.

### Exemplary Implementations for Enhancing Remote Work Productivity Data

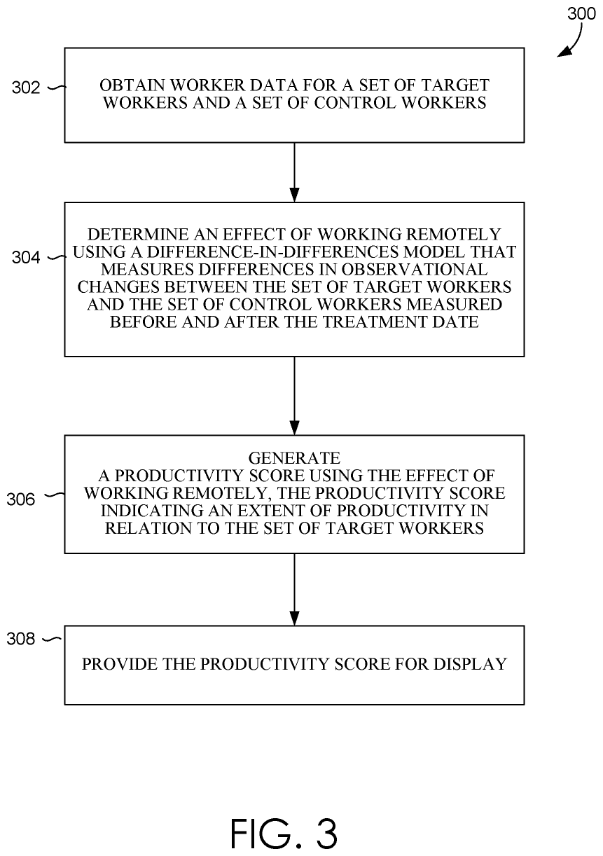

As described, various implementations can be used in accordance with embodiments described herein. FIGS. 3-5 provide methods of facilitating enhancement of remote work productivity data, in accordance with embodiments described herein. The methods 300, 400, and 500 can be performed by a computer device, such as device 600 described below. The flow diagrams represented in FIGS. 3-5 are intended to be exemplary in nature and not limiting.

Turning initially to method 300 of FIG. 3, method 300 is directed to facilitating enhancement of remote work productivity data, in accordance with embodiments of the present technology. Initially, at block 302, worker data is obtained for a set of target workers and a set of control workers. The target workers are generally identified as working in the office prior to a treatment date and working remote after a treatment date, and the control workers are generally identified as working remote before and after the treatment date. In embodiments, worker data obtained for the target and/or control worker set may be based on productivity parameters, for example, provided by a user as a preference. At block 304, an effect of working remotely is determined using a difference-in-differences model that measures differences in observational changes between the set of target workers and the set of control workers measured before and after the treatment date. At block 306, a productivity score is generated using the effect of working remotely. The productivity score indicates an extent of productivity in relation to the set of target workers. At block 308 the productivity score is provided for display. In some cases, the productivity score may be based entirely on the remote work effect. In other cases, the productivity score may be generated based on the remote work effect as well as other productivity measurements or factors.

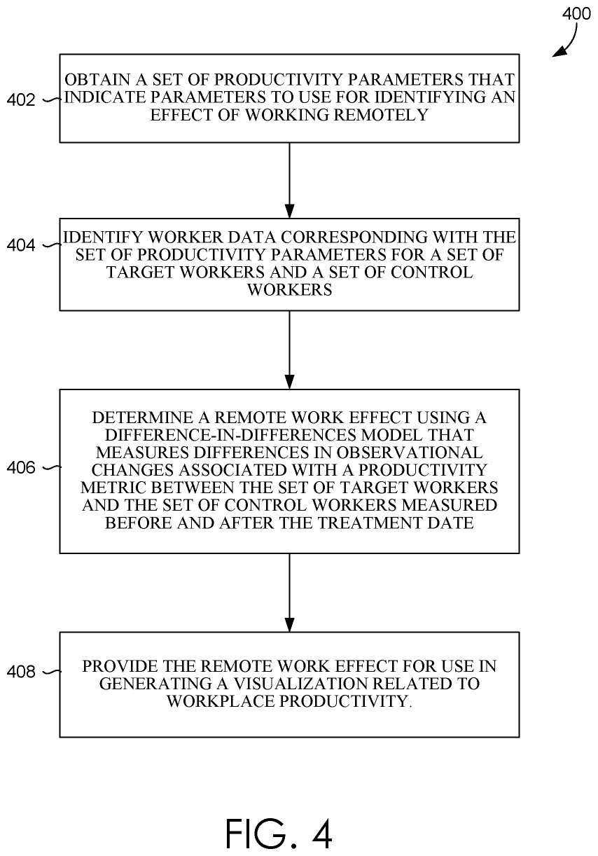

Turning now to FIG. 4, method 400 is directed to facilitating enhancement of remote work productivity data, in accordance with embodiments of the present technology. Initially, at block 402 a set of productivity parameters are obtained that indicate parameters to use for identifying an effect of working remotely. Such productivity parameters may be provided by a user device based on selections or input of a user. At block, 404 worker data corresponding with the set of productivity parameters is identified for a set of target workers and a set of control workers. The target workers are identified as working in the office prior to a treatment date and working remote after a treatment date, and the control workers are identified as working remote before and after the treatment date. In embodiments, the workers for the target set and/or control set may be identified based on attributes indicated in worker set parameters. Thereafter, worker data corresponding with the identified workers can be obtained. At block 406, a remote work effect is determined using a difference-in-differences model that measures differences in observational changes associated with a productivity metric between the set of target workers and the set of control workers measured before and after the treatment date. At block 408, the remote work effect is provided for use in generating a visualization related to workplace productivity. For example, the remote work effect may be provided in a chart or table of data.

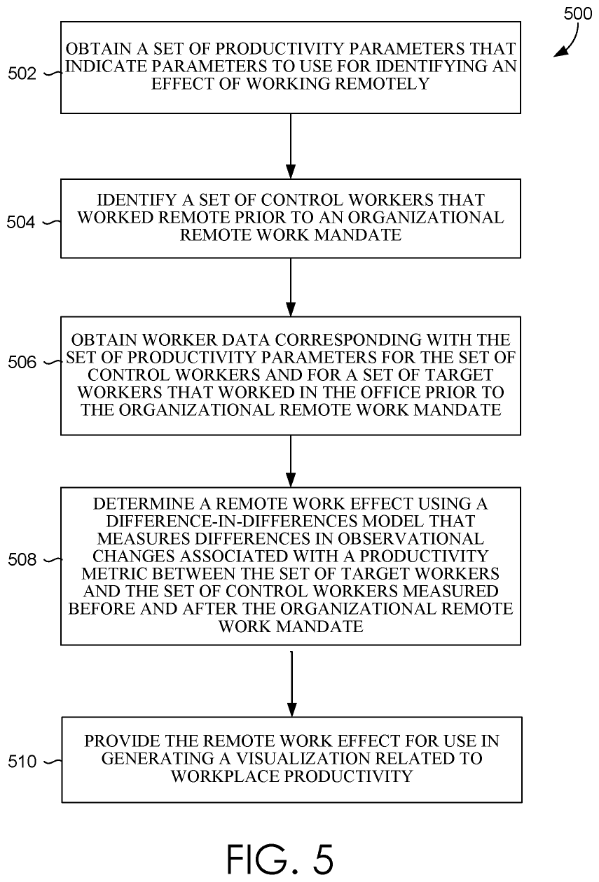

With reference now to FIG. 5, method 500 is directed to facilitating enhancement of remote work productivity data, in accordance with embodiments of the present technology. Initially, at block 502 a set of productivity parameters is obtained that indicate parameters to use for identifying an effect of working remotely. For example, a user may specify productivity parameters including worker set parameters, date parameters, and/or metric parameters. At block 504, a set of control workers that worked remote prior to an organizational remote work mandate is identified. A remote work mandate may be specified by an organization or government indicating that individuals (e.g., all or a portion of individuals) should or are encouraged to work remote from the office buildings. Control workers may be identified in any of a number of ways, including use of a directory, analysis of IP address usage, or the like. At block 506, worker data corresponding with the set of productivity parameters is obtained for the set of control workers and for a set of target workers that worked in the office prior to the organizational remote work mandate. At block 508, a remote work effect is determined using a difference-in-differences model that measures differences in observational changes associated with a productivity metric between the set of target workers and the set of control workers measured before and after the organizational remote work mandate. At block 510, the remote work effect is provided for use in generating a visualization related to workplace productivity. In some cases, the remote work effect may be provided to a user for viewing. In other cases, the remote work effect may be used to generate other productivity data (e.g., productivity score, insights, recommendations, or the like).

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 6 in particular, an exemplary operating environment for implementing aspects of the technology described herein is shown and designated generally as computing device 600. Computing device 600 is just one example of a suitable computing environment and is not intended to suggest any limitation as to the scope of use or functionality of the technology described herein. Neither should the computing device 600 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 6, computing device 600 includes a bus 610 that directly or indirectly couples the following devices: memory 612, one or more processors 614, one or more presentation components 616, input/output (I/O) ports 618, I/O components 620, an illustrative power supply 622, and a radio(s) 624. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 6 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 6 and refer to “computer” or “computing device.”

Computing device 600 typically includes a variety of computer-readable media. Computer-readable media can be any available media that can be accessed by computing device 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer storage media in the form of volatile and/or nonvolatile memory. The memory 612 may be removable, non-removable, or a combination thereof. Exemplary memory includes solid-state memory, hard drives, and optical-disc drives. Computing device 600 includes one or more processors 614 that read data from various entities such as bus 610, memory 612, or I/O components 620. Presentation component(s) 616 present data indications to a user or other device. Exemplary presentation components 616 include a display device, speaker, printing component, and vibrating component. I/O port(s) 618 allow computing device 600 to be logically coupled to other devices including I/O components 620, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 600. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

A computing device may include radio(s) 624. The radio 624 transmits and receives radio communications. The computing device may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive.

What is claimed is:

1. A computing system comprising:
a processor; and
computer storage memory having computer-executable instructions stored thereon which, when executed by the processor, configure the computing system to:
obtain worker data for a set of target workers and a set of control workers, the target workers identified as working in an office prior to a treatment date and working remote from the office after a treatment date, and the control workers identified as working remote from the office before and after the treatment date;
determine an effect of working remotely using a model that measures differences in observational changes between the set of target workers and the set of control workers measured before and after the treatment date;
generate a productivity score using the effect of working remotely, the productivity score indicating an extent of productivity in relation to the set of target workers; and
provide the productivity score for display.

2. The computing system of claim 1, wherein the worker data comprises data related to workers associated with a particular organization.

3. The computing system of claim 1, wherein the treatment date comprises a date or date range associated with a transition from office work to remote work.

4. The computing system of claim 1 further comprising identifying the set of target workers based on a set of user-specified worker set parameters indicating at least one of an organizational level, an organizational role, a demographic, a business unit, a geography, and a worker status.

5. The computing system of claim 1 further comprising:
identifying the set of target workers and the set of control workers based on a set of user-specified worker set parameters indicating at least one of an organizational level, an organizational role, a demographic, a business unit, a geography, and a worker status; and
using the identified set of target workers and the set of control workers to obtain the worker data.

6. The computing system of claim 1 further comprising:
identifying the set of control workers using an organization directory or an Internet Protocol address usage to identify workers inferred to work remotely before the treatment date; and
using the identified set of control workers to obtain the worker data.

7. The computing system of claim 1, wherein the difference-in-difference model includes one or more covariates to control for job roles, seniority, and/or manager status.

8. The computing system of claim 1, further comprising:
obtaining a set of productivity parameters that indicate parameters to use for identifying the effect of working remotely; and
using the set of productivity parameters to select the corresponding worker data for the set of target workers and the set of control workers.

9. The computing system of claim 8, wherein the set of productivity parameters comprise one or more of a worker set parameter, a time parameter, and a metric parameter.

10. The computing system of claim 9, wherein the metric parameter relates to collaboration or technology usage.

11. A computer-implemented method comprising:
referencing a set of productivity parameters that indicate parameters to use for identifying an effect of working remotely;
identifying worker data corresponding with the set of productivity parameters for a set of target workers and a set of control workers, the target workers identified as working in an office prior to a treatment date and working remote from the office after a treatment date, and the control workers identified as working remote from the office before and after the treatment date;
determining a remote work effect using a difference-in-differences model that measures differences in observational changes associated with a productivity metric between the set of target workers and the set of control workers measured before and after the treatment date; and
providing the remote work effect for use in generating a visualization related to workplace productivity.

12. The method of claim 11, wherein at least a portion of the set of productivity parameters are input via a graphical user interface by a user.

13. The method of claim 11, wherein the productivity metric comprises a collaboration metric or a technology usage metric.

14. The method of claim 11, wherein the set of productivity parameters includes one or more of a worker set parameter, a time parameter, and a metric parameter.

15. The method of claim 11, wherein the difference-in-differences model includes a covariate related to an attribute of workers, the attribute comprising a role of workers, a level of workers, a status of workers, a demographic of workers.

16. One or more computer storage media having computer-executable instructions embodied thereon that, when executed by one or more processors, cause the one or more processors to perform a method, the method comprising:
obtaining a set of productivity parameters that indicate parameters to use for identifying an effect of working remotely;
identifying a set of control workers that worked remote from an office prior to an organizational remote work mandate;
obtaining worker data corresponding with the set of productivity parameters for the set of control workers and for a set of target workers that worked in the office prior to the organizational remote work mandate;
determining a remote work effect using a difference-in-differences model that measures differences in observational changes associated with a productivity metric between the set of target workers and the set of control workers measured before and after the organizational remote work mandate; and
providing the remote work effect for use in generating a visualization related to workplace productivity.

17. The media of claim 16, wherein one of the productivity parameters includes an organization level parameter that specifies whether the remote work effect is desired for an organization, a group within the organization, or an individual within the organization.

18. The media of claim 16, wherein identifying a set of control workers that worked remote prior to the organizational remote work mandate comprises using an organization directory, Internet Protocol address usage, or collaboration data.

19. The media of claim 16, wherein obtaining the worker data corresponding with the set of productivity parameters comprises accessing a data store associating workers with worker data.

20. The media of claim 16, wherein the visualization related to the workplace productivity includes a graph, a chart, a statistical measure, a productivity store, an insight, a recommendation, or a combination thereof.
